(19) United States
(12) Patent Application Publication
(10) Pub. No.: US 2018/0013857 A1
(43) Pub. Date: Jan. 11, 2018

(54) LOCAL HART PROXY SERVER FOR MODULAR SMART TRANSMITTER DEVICES

(71) Applicant: Honeywell International, Inc., Morris Plains, NJ (US)

(72) Inventors: Augustene Manohar Shyam Pasala, Hyderabad (IN); Sharath Babu Malve, Rajendranagar (IN); Sarabjit Singh, Hyderabad (IN)

(21) Appl. No.: 15/207,345

(22) Filed: Jul. 11, 2016

(51) Int. Cl. H04L 29/08

(52) U.S. Cl. CPC H04L 67/327; H04L 67/1031; H04L 67/24

(57) ABSTRACT

A method is provided for managing an access request from a server. The method includes receiving, from the server, a request for accessing a field device of a plurality of field devices in an industrial process control and automation system. The method also includes sending, to the server, a response acknowledging that the request is received. The method also includes determining whether the field device is sleeping. The method also includes, responsive to the field device being asleep, holding the request in a queue.

### TECHNICAL FIELD

This disclosure is generally directed to field devices in a plant. More specifically, this disclosure is directed to a local HART proxy server for modular smart transmitter devices.

### BACKGROUND

Industrial control and automation systems are often used to automate large and complex industrial processes. These types of systems routinely include networks that facilitate communications with a wide range of industrial field devices. The field devices can include wireless sensors, wireless actuators, and wireless controllers. The Highway Addressable Remote Transducer (HART) communications protocol is a digital industrial automation protocol. HART can communicate over legacy 4-20 mA analog instrumentation wiring, sharing the pair of wires used by an older system.

HART commands are time sensitive. For the HART commands from the HART server, the response is expected within 240 ms. If delayed, there may need to be retries or other timing issues can exist on the field devices. Monitoring and control action is not optimal in time sensitive process applications involving heterogeneous mode, multi-drop mode, or in modular transmitter designs. The heterogeneous mode can include pressure, temperature, level, flow, and the like at different update rates. Also, in different instances, a device firmware upgrade takes a long time and is not optimal.

### SUMMARY

This disclosure provides a local HART proxy server for modular smart transmitter devices.

In a first example, a method is provided for managing an access request from a server. The method includes receiving, from the server, a request for accessing a field device of a plurality of field devices in an industrial process control and automation system. The method also includes sending, to the server, a response acknowledging that the request is received. The method also includes determining whether the field device is sleeping. The method also includes, responsive to the field device being asleep, holding the request in a queue.

In a second example, an apparatus includes a memory comprising a queue. The apparatus also includes a processing device coupled to the memory. The processing device is configured to receive, from a server, a request for accessing a field device of a plurality of field devices in an industrial process control and automation system. The processing device is also configured to send, to the server, a response acknowledging that the request is received. The processing device is also configured to determine whether the field device is sleeping. The processing device is also configured to, responsive to the field device being asleep, hold the request in the queue.

In a third example, a non-transitory computer readable medium includes a computer program. The computer program comprises computer readable program code for receiving, from the server, a request for accessing a field device of a plurality of field devices in an industrial process control and automation system. The computer readable program code is also for sending, to the server, a response acknowledging that the request is received. The computer readable program code is also for determining whether the field device is sleeping. The computer readable program code is also for, responsive to the field device being asleep, holding the request in a queue.

### BRIEF DESCRIPTION OF THE DRAWINGS

For a more complete understanding of this disclosure and its features, reference is now made to the following description, taken in conjunction with the accompanying drawings, in which:

FIGS. 1 illustrates an example industrial process control and automation system and related details according to this disclosure;

FIG. 2 illustrates an example device for implementing a proxy server according to this disclosure;

FIG. 3 illustrates an example block diagram of a proxy server system according to this disclosure;

FIG. 4 illustrates an example communication diagram of a proxy server system according to this disclosure;

FIG. 5 illustrates an example communication diagram of a multi-drop system according to this disclosure;

FIGS. 6A and 6B illustrate example timing diagrams of a local proxy server according to this disclosure;

FIG. 7 illustrates an example local proxy system with packet aggregation according to this disclosure;

FIGS. 8A and 8B illustrate example proxy servers with differential firmware upgrade capability according to this disclosure; and

FIG. 9 illustrates an example process for managing a request according to this disclosure.

### DETAILED DESCRIPTION

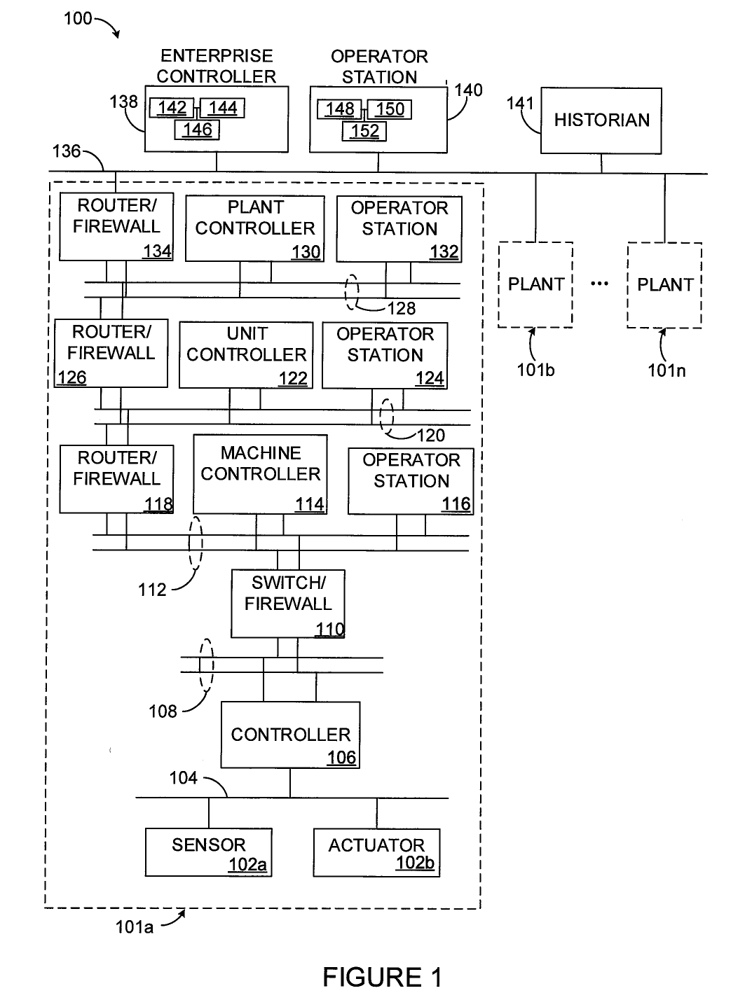

FIGS. 1 through 9, discussed below, and the various examples used to describe the principles of the present invention in this patent document are by way of illustration only and should not be construed in any way to limit the scope of the invention. Those skilled in the art will understand that the principles of the present invention may be implemented in any suitable manner and in any type of suitably arranged device or system.

FIG. 1 illustrates an example industrial process control and automation system 100 and related details according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller, or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running any operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running any operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running any operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running any operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running any operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running any operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a any operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running any operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers could include one or more processing devices 142 and one or more memories 144 for storing instructions and data used, generated, or collected by the processing device(s) 142. Each of the controllers could also include at least one network interface 146, such as one or more Ethernet interfaces or wireless transceivers. Also, each of the operator stations could include one or more processing devices 148 and one or more memories 150 for storing instructions and data used, generated, or collected by the processing device(s) 148. Each of the operator stations could also include at least one network interface 152, such as one or more Ethernet interfaces or wireless transceivers.

Although FIG. 1 illustrates one example of an industrial process control and automation system 100, various changes may be made to FIG. 1. For example, a control and automation system could include any number of sensors, actuators, controllers, operator stations, networks, servers, communication devices, and other components. In addition, the makeup and arrangement of the system 100 in FIG. 1 is for illustration only. Components could be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which information related to an industrial process control and automation system can be transmitted to a remote server. This functionality can be used in any other suitable system.

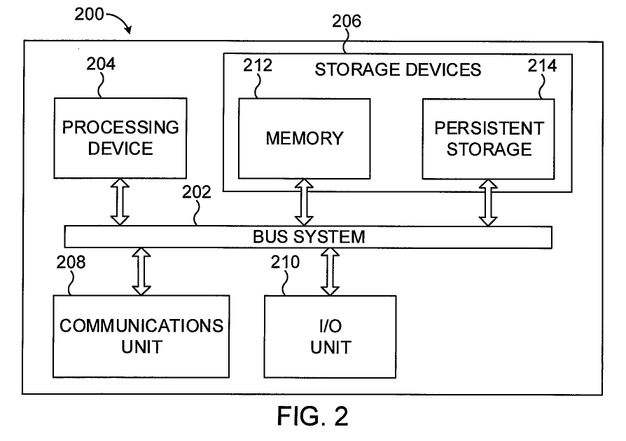

FIG. 2 illustrates an example device 200 for implementing a proxy server according to this disclosure. The device 200 could represent, for example, a field device (such as the sensor 102a or the actuator 102b) or a transmitter associated with a field device in the system 100 of FIG. 1. However, the device 200 could be used in any other suitable system.

As shown in FIG. 2, the device 200 includes a bus system 202, which supports communication between at least one processing device 204, at least one storage device 206, at least one communications unit 208, and at least one input/output (I/O) unit 210. The processing device 204 executes instructions that may be loaded into a memory 212. The processing device 204 may include any suitable number(s) and type(s) of processors or other devices in any suitable arrangement. Example types of processing devices 204 include microprocessors, microcontrollers, digital signal processors, field programmable gate arrays, application specific integrated circuits, and discrete circuitry.

The memory 212 and a persistent storage 214 are examples of storage devices 206, which represent any structure(s) capable of storing and facilitating retrieval of information (such as data, program code, and/or other suitable information on a temporary or permanent basis). The memory 212 may represent a random access memory or any other suitable volatile or non-volatile storage device(s). The persistent storage 214 may contain one or more components or devices supporting longer-term storage of data, such as a ready only memory, hard drive, Flash memory, or optical disc.

The communications unit 208 supports communications with other systems or devices. For example, the communications unit 208 could include a network interface that facilitates communications over at least one Ethernet, HART, FOUNDATION FIELDBUS, cellular, Wi-Fi, universal asynchronous receiver/transmitter (UART), serial peripheral interface (SPI) or other network. The communications unit 208 could also include a wireless transceiver facilitating communications over at least one wireless network. The communications unit 208 may support communications through any suitable physical or wireless communication link(s). The communications unit 208 may support communications through multiple different interfaces, or may be representative of multiple communication units with the ability to communication through multiple interfaces.

The I/O unit 210 allows for input and output of data. For example, the I/O unit 210 may provide a connection for user input through a keyboard, mouse, keypad, touchscreen, or other suitable input device. The I/O unit 210 may also send output to a display, printer, or other suitable output device.

Although FIG. 2 illustrates one example of a device 200, various changes may be made to FIG. 2. For example, components could be added, omitted, combined, further subdivided, or placed in any other suitable configuration according to particular needs. Also, computing devices can come in a wide variety of configurations, and FIG. 2 does not limit this disclosure to any particular configuration of computing device.

One or more embodiments of this disclosure provide a proxy server based field transmitter device. Using a proxy server improves HART server client response (no delays) for time-sensitive HART commands. The proxy server can also provide an improved monitoring and control system. When using a proxy server, the system can enable sleeping of other modules, such as display, sensor, and the like. As used herein, when a device is sleeping, the device may be powered off or in a standby mode. When the device is awake, the device is in a powered on mode or not in standby. Using the proxy server can also enable packet aggregation and decompression. The local proxy server also enables an optimized firmware upgrade.

The proxy server reduces request-response time, thereby enabling better and faster control action on a multi-drop loop line. The proxy server enhances device components' lifetime by enabling optimal sleep for the components. Proxy server can be used to upgrade firmware of other modules (sensor firmware, display firmware) in an optimal procedure.

The proxy server can also be used to increase the speed of the firmware upgrade process on multi-drop devices. The proxy server also reduces an overall current consumption of the field device. For example, a display module need not be active all the time, and the proxy server wakes up the display module based on user red-button operation. The additional firewall in the proxy server increases the safety of the device and bad configurations or firmware binary upgrades can be avoided at no additional cost.

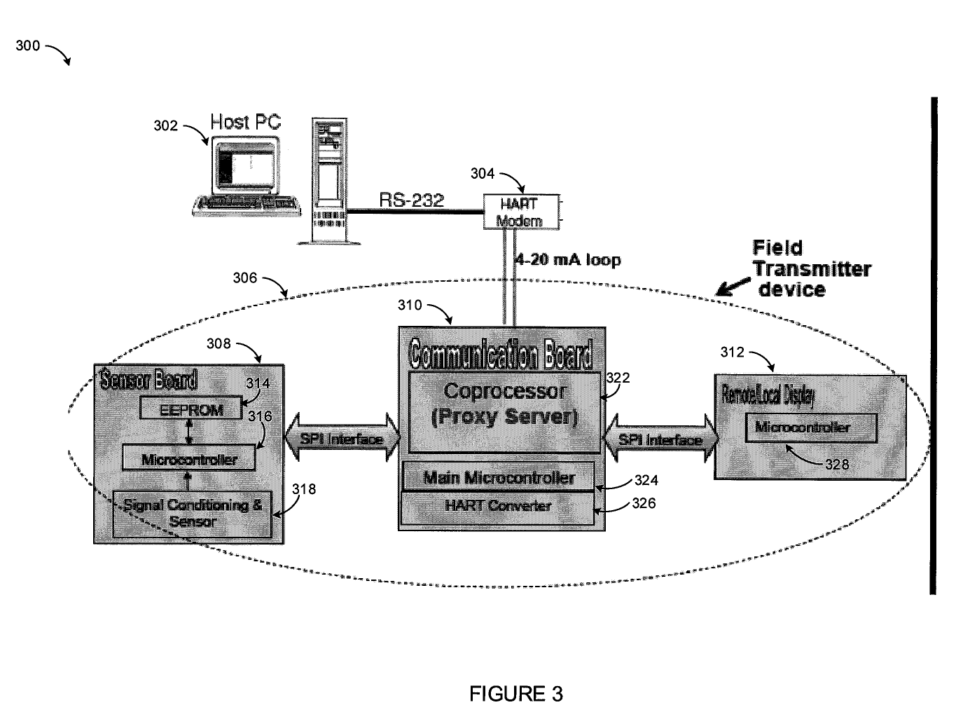

FIG. 3 illustrates an example block diagram of a proxy server system 300 according to this disclosure. For ease of explanation, the system 300 is described as supporting the industrial process control and automation system 100 of FIG. 1. However, the system 300 could be supported by any other suitable system. Parts of system 300 can be implemented in a device, such as device 200 as shown in FIG. 2.

In FIG. 3, system 300 includes HART host 302, which is configured to communicate through a HART modem 304 to a field transmitter device 306. One or more of the components 302-306 used herein can be implemented in part as processing circuitry, instructions on a non-transitory computer readable medium, as a processor, and the like.

In one or more embodiments herein, a field transmitter device 306 can be a field device used in a process control system supporting protocols such as HART, Wireless HART, Foundation Fieldbus, ISA100, Profibus DP, PA, Profinet, etc. In different embodiments of this disclosure, the field transmitter device 306 can represent, or be represented by sensor 102a or actuator 102b as shown in FIG. 1.

In an embodiment of this disclosure, the field transmitter device 306 further includes a sensor board 308, communication board 310, and remote local display 312. The sensor board 308 can control a sensor for taking measurements of different environment changes. The sensor board 308 can include memory such as, but not limited to, EEPROM 314, a microcontroller 316, and a signal conditioning module and sensor 318.

The communication board 310 can communicate with different components of the field transmitter device 306 as well as the modem 304. The communication board can include a co-processor 322 that can operate as a proxy server, a microcontroller 324, and a HART converter 326 configured to communicate over a 4-20 mA loop.

The remote local display 312 can include a microcontroller 328. The remote local display 312 can provide readouts for current and/or past measurements, configuration settings, and the like.

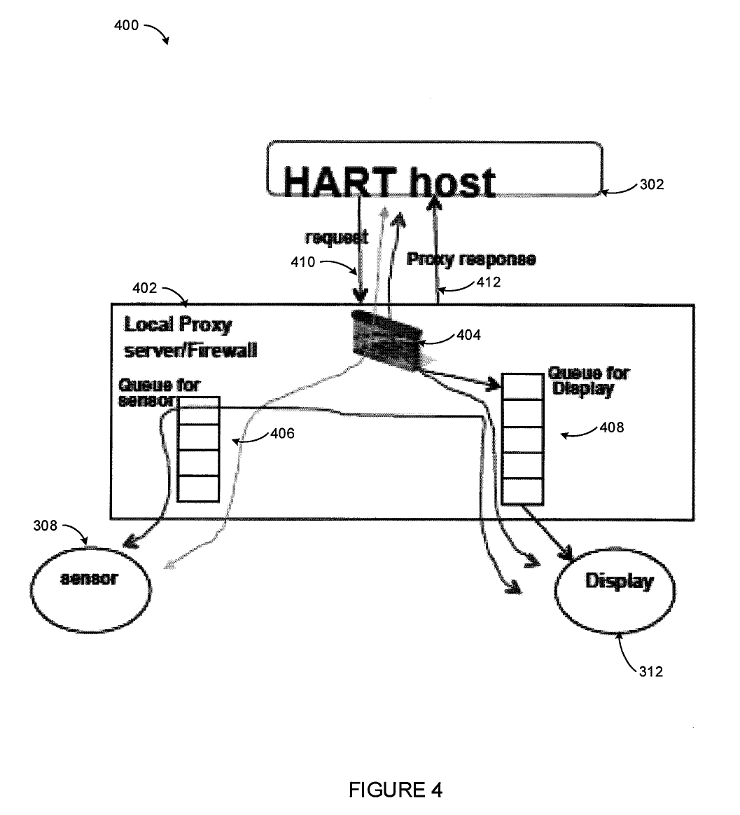

FIG. 4 illustrates an example communication diagram of a proxy server system 400 according to this disclosure. In FIG. 4, system 400 includes HART host 302 configured to communicate with a local proxy server 402. Local proxy server 402 can be implemented in part as processing circuitry, instructions on a non-transitory computer readable medium, as a processor, and the like.

In FIG. 4, the local proxy server 402 includes a firewall 404, a queue 406 for sensor 308 and a queue 408 for display 312. The multiple queues 406 and 408 can include adaptive queue sizes. The queues 406-408 and adaptive queue sizes are maintained by the proxy server 402 to store data packets for different components of the field device.

One or more embodiments of this disclosure recognize and take into account that a 4-20 mA loop field transmitter is limited by availability of current. Whenever HART host 302 sends request 410, such as a read/write command, where the response requirement is a maximum up to 250 ms, if a response 412 is not received from the HART enabled field device, the request times out. To achieve this timing requirement, a field device may need to be awake at all times.

One or more of the components (like sensor 308, display 312, etc.) on the field device do not need to be active at all times other than to meet the timing requirement for request responses. Enabling sleep in these components can result in a reduction of overall current consumption. A server and firewall 404 running on a microcontroller, in the field device, can put components on the field transmitter to sleep, thus reducing overall current consumption.

Whenever a read/write command, such as request 410, is received, such as for display module 312 from HART host 302, the response 412 is generated (within the required time, such as, for example 250 ms, to meet HART host requirements) upfront by the proxy server 402. Until the display 312 comes out of sleep, the data packets are buffered in an adaptive queue 408.

In one embodiment, the queue sizes can be constant. In other embodiments, queue sizes for different components (sensor 308, display 312, etc.) are different based on their respective sleep times. The sleep times for different modules (e.g., display 312) can be user configurable. The sleep time for the sensor may be defined based on accuracy and sensing parameter requirements. The proxy server 402 can act as a sleep scheduler for different devices based on user red-button operations and/or HART host 302 activity. The proxy server 402 can wake up the display 312 based on user red-button operations. The proxy server 402 can perform dynamic prioritization of sleep/wake of different modules.

In one or more embodiments of this disclosure, proxy server 402 maintains adaptive queues for communication between different modules (between HART host 302 and sensor 308, HART host 302 and display 312, and display 312 and sensor 308) to enable optimal sleep durations for different modules.

The proxy server 402 reduces current consumption and the firewall 404 enables safety by avoiding unauthorized and out of bound configurations.

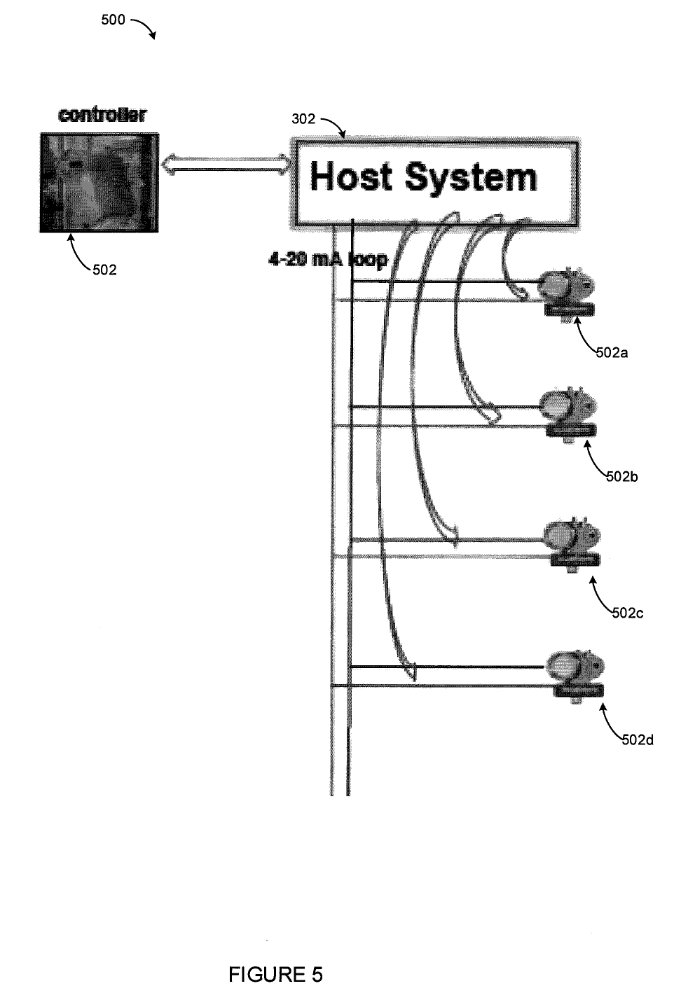

FIG. 5 illustrates an example communication diagram of a multi-drop system 500 according to this disclosure. In FIG. 5, system 500 includes host 302, controller 502, and field devices 502a-502d. Controller 502 and/or host 302 can be implemented in part as processing circuitry, instructions on a non-transitory computer readable medium, as a processor, and the like.

In FIG. 5, multi-drop allows multiple HART devices to be connected (networked) on a single current loop. Using a local proxy server within field devices 502a-502d, a faster request response exchange achieves faster round robin scheduling, thereby enabling better and faster control action in the process. The local proxy server is also useful in time sensitive critical plant operations involving heterogeneous field devices measuring different parameters such as level, temperature, pressure at different update rates. Using a local proxy server within controller 502, a faster request response exchange achieves a faster firmware download on multi-drop devices.

Without a local proxy server, a response time per HART transaction could be nearly 140 ms in a temperature transmitter and nearly 60 ms in pressure sensor. The delay in response can be eliminated with a local proxy server. Firmware upgrade time can be reduced from hours to minutes.

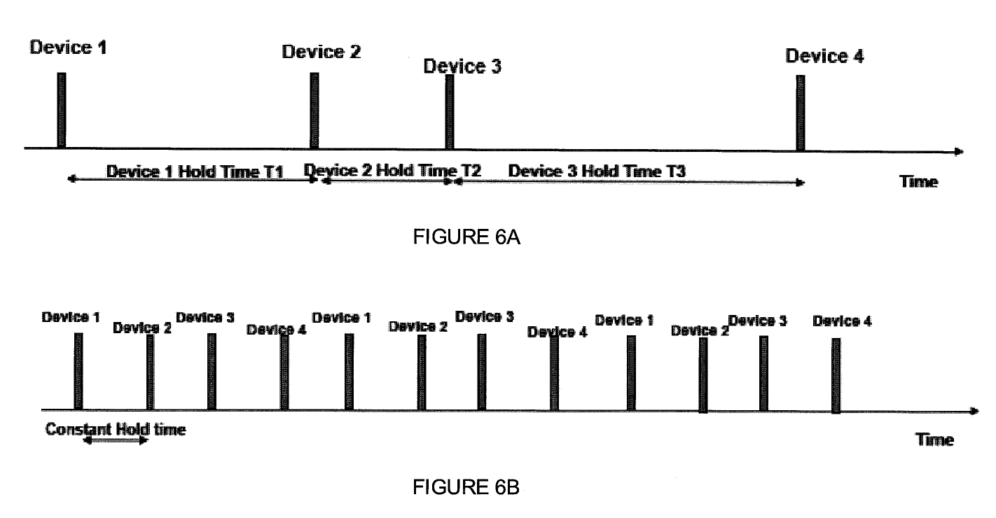

FIGS. 6A and 6B illustrate example timing diagrams of a local proxy server according to this disclosure. In FIG. 6A, without using a local proxy server, there is a variable time delay to monitor/read/write to each different device. The variable delay is due to different device hold times. In FIG. 6B, with a local proxy server, there is a constant and reduced time delay for requests, such as monitor/read/write commands, with each different device compared to FIG. 6A. This optimized device monitoring enhances overall plant control actions and faster firmware downloads onto different modules of the field device.

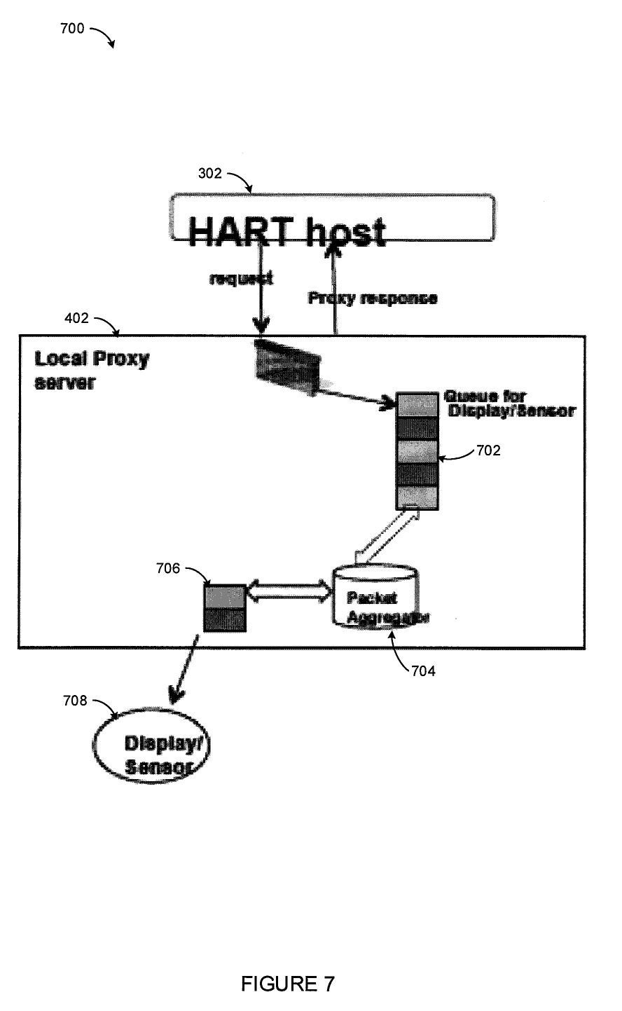

FIG. 7 illustrates an example local proxy system 700 with packet aggregation according to this disclosure. In FIG. 7, system 700 includes a queue 702 for the requests sent to the field devices, a packet aggregator 704, and a streamlined queue 706. Proxy system 700 can be implemented as part of processing circuitry, instructions on a non-transitory computer readable medium, as a processor, and the like.

In FIG. 7, the queue includes the requests as they are received for different modules, for example, a display or sensor 708. The packet aggregator 704 receives these requests, which can be for monitoring a module, reading from the module, or writing to the module. If any of the requests are repetitive by the time the module is awake, the packet aggregator 704 can aggregate the requests and set up the streamlined queue 706. For example, if by the time a sensor awakes from sleep, there are multiple similar read requests, the packet aggregator 704 can combine these requests into one request.

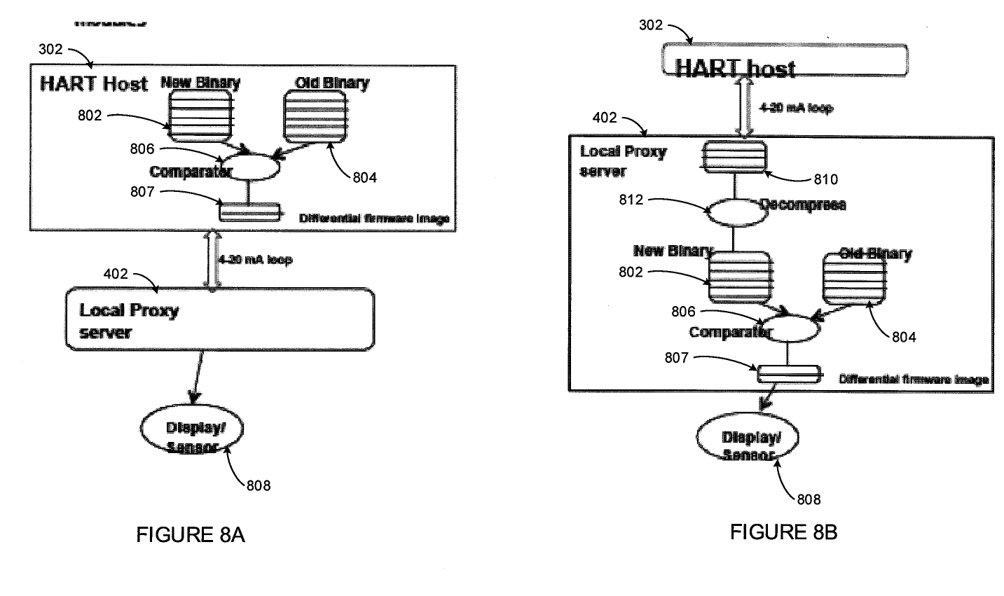

FIGS. 8A and 8B illustrate example proxy servers with differential firmware upgrade capability according to this disclosure. In one or more embodiments of this disclosure, a local proxy server 402 decompresses firmware binary packet received from HART host 302 before upgrading a module (e.g., display or sensor) firmware image. Using differential firmware upgrading reduces overall firmware bytes and transfer time over 4-20 mA loop. A comparator can be handled offline or through DTM or DD

In FIG. 8A, host 302 sends differential firmware binary bytes instead of the whole new binary image. The host 302 includes a new binary image 802 and an old binary image 804. A comparator 806 compares the images 802 and 804 and produces a differential firmware image 807 with the differences between images 802 and 804. The image 807 is sent to the local proxy server 402.

In FIG. 8B, host 302 sends a whole firmware image 810 that is a compressed new binary image 802 and old binary image 804 to the local proxy server 402. The decompressor 812 decompresses the whole firmware image 810 and compares the new binary image 802 with the old binary image 804. Then, the differential firmware image 807 with only the memory sections that are modified can be transmitted to the modules, such as the sensor or display 808 modules.

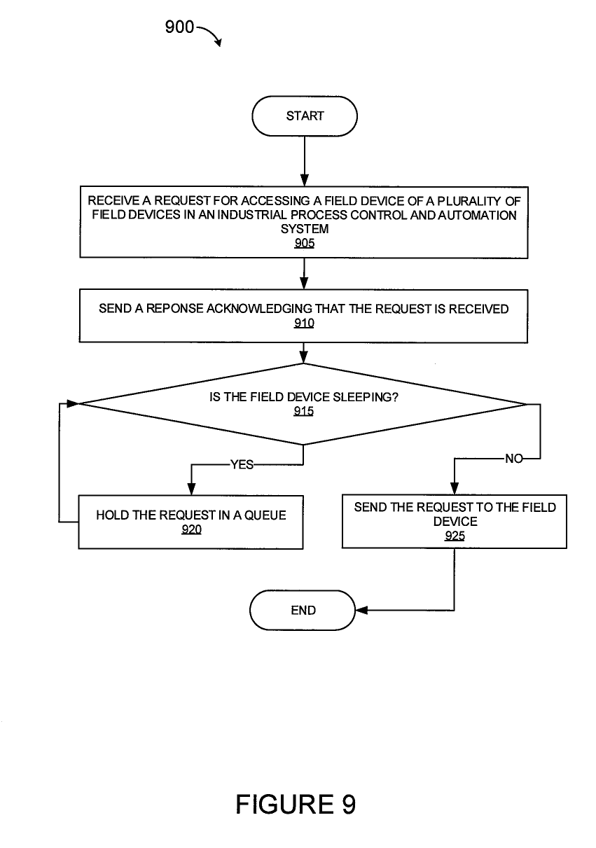

FIG. 9 illustrates an example process 900 for managing a request according to this disclosure. The process 900 provides for receiving and responding to a request from a server. Process 900 can be executed within system 306 of FIG. 3 and/or by device 200 of FIG. 2.

At operation 905, a processor is configured to receive, from a server, a request for accessing a field device of a plurality of field devices in an industrial process control and automation system. In one embodiment, the server can be a HART host. In different embodiments, the accessing can be for monitoring the field device, reading from the field device, or writing to the field device.

At operation 910, a processor is configured to send, to the server, a response acknowledging that the request is received. At operation 915, the processor is configured to determine whether the field device module (like sensor or display) is sleeping. To determine whether the field device module is sleeping, the processor can check a schedule of when the module should be sleeping and/or ping the field device module to verify a status.

If the field device module is sleeping, at operation 920, the processor is configured to hold the request in a queue. If the field device module is not sleeping, at operation 925, the processor is configured to send the request to the field device modules.

As discussed herein, one or more steps can be performed by a processor or different components controlled by the processor. However, the processor can directly perform the steps performed by components controlled by the processor.

Although FIG. 9 illustrates one example of a process 900 for managing an access request in an industrial process control and automation system, various changes may be made to FIG. 9. For example, while FIG. 9 shows a series of steps, various steps could overlap, occur in parallel, occur in a different order, or occur any number of times. In addition, the process 900 could include any number of requests.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed:

1. A method comprising:
receiving, from a server, a request for accessing a field device of a plurality of field devices in an industrial process control and automation system;
sending, to the server, a response acknowledging that the request is received;
determining whether the field device is sleeping; and
responsive to the field device being asleep, holding the request in a queue.

2. The method of claim 1, further comprising:
responsive to the field device being awake, sending the request to the field device.

3. The method of claim 1, wherein a size of the queue is based on a sleep time for the field device.

4. The method of claim 1, further comprising:
identifying a plurality of requests in the queue; and
combining at least two of the plurality of requests to form a streamlined queue,
wherein sending the request to the field device comprises sending the combined requests in the streamlined queue to the field device.

5. The method of claim 1, further comprising:
receiving, from the server, a differential firmware image for upgrading a device firmware of the field device, wherein the differential firmware is a result of a comparison between a new binary image and an old binary image; and
sending the differential firmware image to the field device.

6. The method of claim 1, further comprising:
receiving, from the server, a compressed firmware image;
decompressing the compressed firmware image to form a new binary image and an old binary image;
comparing the new binary image to the old binary image to form a differential firmware image; and
sending the differential firmware image to the field device.

7. The method of claim 3, further comprising:
scheduling the sleep time for the field device.

8. An apparatus comprising:
a memory comprising a queue; and
a processing device coupled to the memory and configured to:
receive, from a server, a request for accessing a field device of a plurality of field devices in an industrial process control and automation system;
send, to the server, a response acknowledging that the request is received;
determine whether the field device is sleeping; and
responsive to the field device being asleep, hold the request in the queue.

9. The apparatus of claim 8, wherein the processing device is further configured to:
responsive to the field device being awake, send the request to the field device.

10. The apparatus of claim 8, wherein a size of the queue is based on a sleep time for the field device.

11. The apparatus of claim 8, wherein the processing device is further configured to:
identify a plurality of requests in the queue;
combine at least two of the plurality of requests to form a streamlined queue; and
send the combined requests in the streamlined queue to the field device.

12. The apparatus of claim 8, wherein the processing device is further configured to:
receive, from the server, a differential firmware image for upgrading a device firmware of the field device, wherein the differential firmware is a result of a comparison between a new binary image and an old binary image; and
send the differential firmware image to the field device.

13. The apparatus of claim 8, wherein the processing device is further configured to:
receive, from the server, a compressed firmware image;
decompress the compressed firmware image to form a new binary image and an old binary image;
compare the new binary image to the old binary image to form a differential firmware image; and
send the differential firmware image to the field device.

14. The apparatus of claim 10, wherein the processing device is further configured to:
schedule the sleep time for the field device.

15. A non-transitory computer readable medium embodying a computer program, the computer program comprising computer readable program code for:
receiving, from a server, a request for accessing a field device of a plurality of field devices in an industrial process control and automation system;
sending, to the server, a response acknowledging that the request is received;
determining whether the field device is sleeping; and
responsive to the field device being asleep, holding the request in a queue.

16. The non-transitory computer readable medium of claim 15, wherein the computer readable program code further comprises computer readable program code for:
responsive to the field device being awake, sending the request to the field device.

17. The non-transitory computer readable medium of claim 15, wherein a size of the queue is based on a sleep time for the field device.

18. The non-transitory computer readable medium of claim 15, wherein the computer readable program code further comprises computer readable program code for:
identifying a plurality of requests in the queue; and
combining at least two of the plurality of requests to form a streamlined queue,
wherein sending the request to the field device comprises sending the combined requests in the streamlined queue to the field device.

19. The non-transitory computer readable medium of claim 15, wherein the computer readable program code further comprises computer readable program code for:
receiving, from the server, a differential firmware image for upgrading a device firmware of the field device, wherein the differential firmware is a result of a comparison between a new binary image and an old binary image; and
sending the differential firmware image to the field device.

20. The non-transitory computer readable medium of claim 15, wherein the computer readable program code further comprises computer readable program code for:
receiving, from the server, a compressed firmware image;
decompressing the compressed firmware image to form a new binary image and an old binary image;
comparing the new binary image to the old binary image to form a differential firmware image; and
sending the differential firmware image to the field device.
